(19) United States
(12) Patent Application Publication
(10) Pub. No.: US 2017/0288969 A1
(43) Pub. Date: Oct. 5, 2017

(54) METHOD AND DEVICE FOR ESTIMATING A BANDWIDTH

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Boyuan LIU, Tianjin (CN)

(21) Appl. No.: 15/247,889

(22) Filed: Aug. 25, 2016

Related U.S. Application Data
(63) Continuation of application No. PCT/CN2016/088979, filed on Jul. 6, 2016.

(30) Foreign Application Priority Data
Mar. 31, 2016 (CN) 201610201977.9

(51) Int. Cl. H04L 12/24; H04L 12/26

(52) U.S. Cl. CPC H04L 41/0896; H04L 43/0829; H04L 43/0894

(57) ABSTRACT

Embodiments of the disclosure provide a method and apparatus for estimating a bandwidth. A transmitter receives an estimated bandwidth and a packet loss ratio estimation parameter; calculates a packet loss ratio as a function of the packet loss ratio estimation parameter; and determines whether the packet loss ratio is less than a preset packet loss ratio, and determines whether the estimated bandwidth is more than a preset bandwidth and more than a current transmit bandwidth; and if so, then the transmitter determines a bandwidth in a bandwidth interval as a new current transmit bandwidth, where the bandwidth interval is more than a preset multiple of the current transmit bandwidth but no more than the estimated bandwidth, where the preset multiple is more than or equal to 1.08 times.

### CROSS-REFERENCE TO RELATED APPLICATIONS

This application is a continuation of International Application No. PCT/CN2016/088979, filed on Jul. 6, 2016, which is based upon and claims priority to Chinese Patent Application No. 201610201977.9, filed on Mar. 31, 2016, the entire contents of which are incorporated herein by reference

### TECHNICAL FIELD

The disclosure relates to the field of communications, and particularly to a method and device for estimating a bandwidth.

### BACKGROUND

A bandwidth is an important parameter in network communication, which reflects a capacity of a network to transmit data. In the prior art, in order to make full use of network resources, the bandwidth tends to be adjusted dynamically according to a real condition to thereby improve the utilization ratio of network resources.

In Web Real-Time Communication (WebRTC), a transmitter typically estimates a transmit bandwidth thereof in the WebRTC bandwidth estimation algorithm particularly as follows:

Firstly a receiver estimates a bandwidth (referred hereinafter an estimated bandwidth) as a function of a packet arrival time and transmits to the transmitter; and also transmits a packet loss ratio estimation parameter to the transmitter;

Then the transmitter receives the estimated bandwidth and the packet loss ratio estimation parameter transmitted by the receiver; and calculates a packet loss ratio as a function of the packet loss ratio estimation parameter. If the packet loss ratio ranges from 2% to 10%, then the current transmit bandwidth will not be adjusted; if the packet loss ratio is less than 2%, then the current transmit bandwidth will be increased by 8%; and if the packet loss ratio is more than 10%, then the current transmit bandwidth will be decreased.

In implanting the process of the disclosure, the inventors of the disclosure have found that there is at least the relevant technical problem: once the packet loss ratio is less than 2%, then the transmit bandwidth will be increased by only 8%, but the transmit bandwidth may not be increased effectively. For example, if the transmit bandwidth can be increased by 20% in reality, then the transmit bandwidth will have to be increased for three times to this effect. Accordingly in the prior art, the transmit bandwidth may not be increased rapidly taking into account the real condition, so that the transmit bandwidth may be increased so slowly that the transmit bandwidth may not be accommodated as needed, thus result in wasting network resources.

### SUMMARY

Embodiments of the disclosure provide a method and apparatus for estimating a bandwidth so as to address such a problem in the prior art that the transmit bandwidth may not be increased rapidly according to the real condition, so that the transmit bandwidth may be increased so slowly that the transmit bandwidth may not be accommodated as needed, thus wasting network resources.

Particular technical solutions according to the embodiments of the disclosure are as follows:

In an aspect, an embodiment of the disclosure provides a method for estimating a bandwidth, the method including:
receiving, by a transmitter, a packet loss ratio estimation parameter transmitted by a receiver;
calculating a packet loss ratio as a function of the packet loss ratio estimation parameter;
determining whether the packet loss ratio is less than a preset packet loss ratio, and determining whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determining a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

In another aspect, an embodiment of the disclosure provides a electronic device, the electronic device including:
at least one processor; and
a memory communicably connected with the at least one processor for storing instructions executable by the at least one processor, wherein execution of the instructions by the at least one processor causes the at least one processor to:
receive a packet loss ratio estimation parameter transmitted by a receiver;
calculate a packet loss ratio as a function of the packet loss ratio estimation parameter;
determine whether the packet loss ratio is less than a preset packet loss ratio, and determine whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determine a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

In another aspect, an embodiment of the disclosure provides a non-transitory computer-readable storage medium storing executable instructions that, when executed by an electronic device with a touch-sensitive display, cause the electronic device to:
receive a packet loss ratio estimation parameter transmitted by a receiver;
calculate a packet loss ratio as a function of the packet loss ratio estimation parameter;
determine whether the packet loss ratio is less than a preset packet loss ratio, and determine whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determine a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

An advantageous effect of the embodiments of the disclosure lies in that in the embodiments of the disclosure, in order to improve reasonably a speed at which the transmit bandwidth is increased to thereby improve the utilization ratio of network resources, the transmitter receives the estimated bandwidth and the packet loss ratio estimation parameter transmitted by the receiver; calculates the packet loss ratio as a function of the packet loss ratio estimation parameter; and determines whether the packet loss ratio is less than the preset packet loss ratio, and determines whether the estimated bandwidth is more than the preset bandwidth and more than the current transmit bandwidth; and if the packet loss ratio is less than the preset packet loss ratio, and the estimated bandwidth is more than the preset bandwidth and more than the current transmit bandwidth, then the transmitter will determine a bandwidth in the bandwidth interval as the new current transmit bandwidth, where the bandwidth interval is more than 1.08 times the current transmit bandwidth but no more than the estimated bandwidth, so that in the embodiments of the disclosure, if it is determined that the estimated bandwidth is more than the preset bandwidth (that is, there is a good network condition), then the transmit bandwidth can be increased rapidly by more than 8% of the current transmit bandwidth in the embodiments of the disclosure, to thereby improve the speed at which the transmit bandwidth is increased so as to make full use of network resources.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for estimating a bandwidth in accordance with some embodiments.

FIG. 2 is an exemplary flow chart of a method for estimating a bandwidth in accordance with some embodiments;

FIG. 3 is a first schematic structural diagram of an apparatus for estimating a bandwidth in accordance with some embodiments;

FIG. 4 is a second schematic structural diagram of an apparatus for estimating a bandwidth in accordance with some embodiments; and

FIG. 5 is a schematic structural diagram of an electronic device in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The embodiments of the disclosure provide a method and apparatus for estimating a bandwidth. In the embodiments of the disclosure, in order to improve reasonably a speed at which a transmit bandwidth is increased to thereby improve the utilization ratio of network resources, a transmitter receives an estimated bandwidth and a packet loss ratio estimation parameter transmitted by a receiver; calculates a packet loss ratio as a function of the packet loss ratio estimation parameter; and determines whether the packet loss ratio is less than a preset packet loss ratio, and determines whether the estimated bandwidth is more than a preset bandwidth and more than a current transmit bandwidth; and if the packet loss ratio is less than the preset packet loss ratio, and the estimated bandwidth is more than the preset bandwidth and more than the current transmit bandwidth, then the transmitter will determine a bandwidth in a bandwidth interval as a new current transmit bandwidth, where the bandwidth interval is more than 1.08 times the current transmit bandwidth but no more than the estimated bandwidth, so that in the embodiments of the disclosure, if it is determined that the estimated bandwidth is more than the preset bandwidth (that is, there is a good network condition), then the transmit bandwidth can be increased rapidly by more than 8% of the current transmit bandwidth in the embodiments of the disclosure to thereby improve the speed at which the transmit bandwidth is increased so as to make full use of network resources.

In order to facilitate further understanding, the technical solutions according to the embodiments of the disclosure will be described below.

### First Embodiment

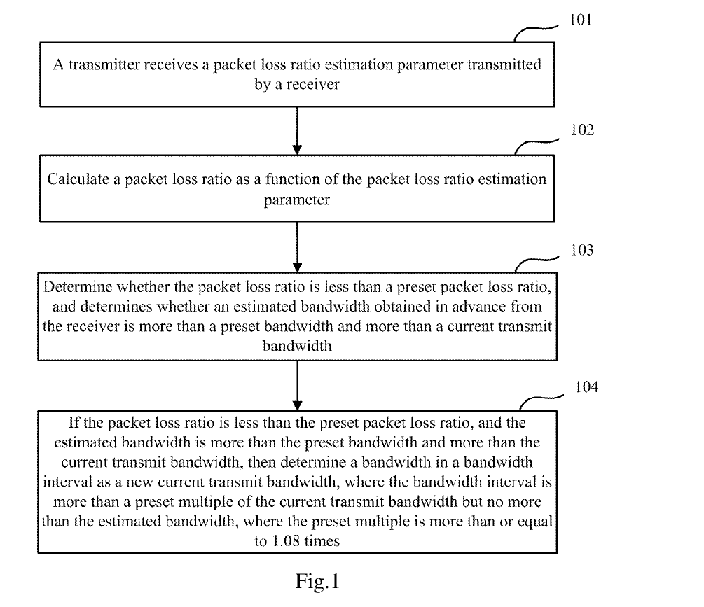

As illustrated in FIG. 1, there is a schematic flow chart of a method for estimating a bandwidth according to an embodiment of the disclosure, where the method includes the following steps:

Step 101, a transmitter receives a packet loss ratio estimation parameter transmitted by a receiver.

Step 102, the transmitter calculates a packet loss ratio as a function of the packet loss ratio estimation parameter.

In an embodiment, the transmitter can receive the packet loss ratio estimation parameter transmitted by the receiver particularly in the following steps:

Step A1, the transmitter receives a Real-time Transport Control Protocol (RTCP) message transmitted by the receiver.

Step A2, the transmitter obtains the packet loss ratio estimation parameter from the RTCP message.

In an embodiment, the transmitter can obtain the packet loss ratio estimation parameter from the RTCP message particularly as in the prior art, so the embodiment of the disclosure will not be limited thereto.

Step 103, the transmitter determines whether the packet loss ratio is less than a preset packet loss ratio, and determines whether an estimated bandwidth which is obtained in advance from the receiver is more than a preset bandwidth and more than a current transmit bandwidth.

In an embodiment, the preset bandwidth is a parameter which can indicate a good current network condition, and the preset bandwidth can be a fixed value, or can be a value determined dynamically as a function of the current transmit bandwidth. For example, the preset bandwidth can be determined in Equation (1) of:

p′=α×B;α>1 (1)

Where p′ represents the preset bandwidth; B represents the current transmit bandwidth; and α represents a first weight coefficient.

In a particular implementation, the preset bandwidth can be set as needed in reality, for example, the preset bandwidth can be set as a function of the estimated bandwidth transmitted by the receiver (as represented in Equation (2)):

p′=ε×p;ε≦1 (2)

Where p′ represents the preset bandwidth; p represents the estimated bandwidth; and ε represents a second weight coefficient.

Step 104, if the packet loss ratio is less than the preset packet loss ratio, and the estimated bandwidth is more than the preset bandwidth and more than the current transmit bandwidth, then the transmitter determines a bandwidth in a bandwidth interval as a new current transmit bandwidth, where the bandwidth interval is more than a preset multiple of the current transmit bandwidth but no more than the estimated bandwidth, where the preset multiple is more than or equal to 1.08 times.

In an embodiment, if one of the following conditions is satisfied, then the new current transmit bandwidth can be determined as in the prior art:

(1) The packet loss ratio is more than the preset packet loss ratio;

(2) The estimated bandwidth is no more than the preset bandwidth; and

(3) The estimated bandwidth is no more than the current transmit bandwidth.

In an embodiment, the preset packet loss ratio can be 2%, or can be more than 2% and less than a preset value (e.g., 3%). In a particular implementation, the preset packet loss ratio can be determined as needed in reality, so the embodiment of the disclosure will not be limited thereto. Of course, in order to guarantee the efficiency of data transmission, and to avoid the packet loss ratio from growing, the preset packet loss ratio can alternatively be set less than 2%. Of course, the lower the preset packet loss ratio is, the better the current network condition will be, and the larger the transmit bandwidth can be increased.

Thus in the embodiments of the disclosure, when it is determined from the estimated bandwidth and the packet loss ratio that the packet loss ratio is less than the preset packet loss ratio, and the estimated bandwidth is more than the preset bandwidth and more than the current transmit bandwidth, then this indicates that the current network condition is good, and the transmit bandwidth can be improved significantly, so the transmit bandwidth may be increased by more than 8%, so that the disclosure can increase the transmit bandwidth more rapidly, make full use of network resources, and satisfy the demand of a user, and improve the experience of the user, as compared with the prior art.

Particularly in order to facilitate further understanding, the method for estimating a bandwidth according to the embodiment of the disclosure will be described below in details as follows:

In an embodiment, in order to improve the reasonability of determining the new current transmit bandwidth (that is, the transmit bandwidth will be neither increased by such a small factor that it has to be increased for a number of times, nor increased by such a large factor that it may not be appropriate for the current network condition, thus degrading the data packet ratio). In an embodiment of the disclosure, the step 104 (where a bandwidth is determined in the bandwidth interval as the new current transmit bandwidth) can be performed particularly by determining the new current transmit bandwidth as a function of the estimated bandwidth using a preset bandwidth estimation model, so that in an embodiment of the disclosure, the new current transmit bandwidth is determined again as a function of the estimated bandwidth, thus improving the utilization ratio of the bandwidth as compared with the prior art where only the estimated bandwidth is a threshold. The estimated bandwidth is an important parameter which can reflect a network condition, so the new current transmit bandwidth can be determined as a function of this parameter to thereby determine the transmit bandwidth as a function of the real network condition so as to improve the reasonability of determining the transmit bandwidth.

In an embodiment, the preset bandwidth estimation model can be as represented in Equation (3) of:

B′=1.08×B+(Bᵣ−B)×λ (3)

In Equation (3), B′ represents the new current transmit bandwidth; B represents the current transmit bandwidth; Bᵣ represents the estimated bandwidth; and λ represents a first preset coefficient, where the first preset coefficient is used to determine a reasonable new bandwidth, and can be determined as a function of a really measured value, or can be estimated as a function of the network condition, for example, it can be determined as a function of the amount of data being transmitted, and to be transmitted in a preset length of time, for example, it can be determined as a function of the historical amounts of data exchanged between the receiver and the transmitter, which are counted previously, so the embodiment of the disclosure will not be limited thereto.

In an embodiment, the preset bandwidth estimation model can be as represented in Equation (4) of:

B′=φ×B;φ>1.08 (4)

Where B′ represents the new current transmit bandwidth; B represents the current transmit bandwidth; and φ represents a second preset coefficient, where the second preset coefficient is used to determine a reasonable new bandwidth, and can be determined as a function of a really measured value, or can be estimated as a function of the network condition, for example, it can be determined as a function of the amount of data being transmitted, and to be transmitted in a preset length of time, so the embodiment of the disclosure will not be limited thereto.

It shall be noted that any preset bandwidth estimation model for increasing the transmit bandwidth by more than 8% under the good network condition will be applicable to the embodiment of the disclosure, so the embodiment of the disclosure will not be limited thereto.

In summary, in the embodiments of the disclosure, if the transmit bandwidth can be improved by a larger factor under the good network condition, then the transmit bandwidth will be increased by more than 8%, so that the transmit bandwidth can be increased more rapidly, network resources can be made full use of, and the demand of the user can be better satisfied, thus improving the experience of the user, as compared with the prior art.

More over in the embodiments of the disclosure, the factor by which the transmit bandwidth is increased can be determined as a function of the estimated bandwidth using the preset bandwidth estimation model, so that the new current transmit bandwidth can be determined more reasonably than the prior art where the factor by which the transmit bandwidth is increased only as a function of the packet loss ratio.

### Second Embodiment

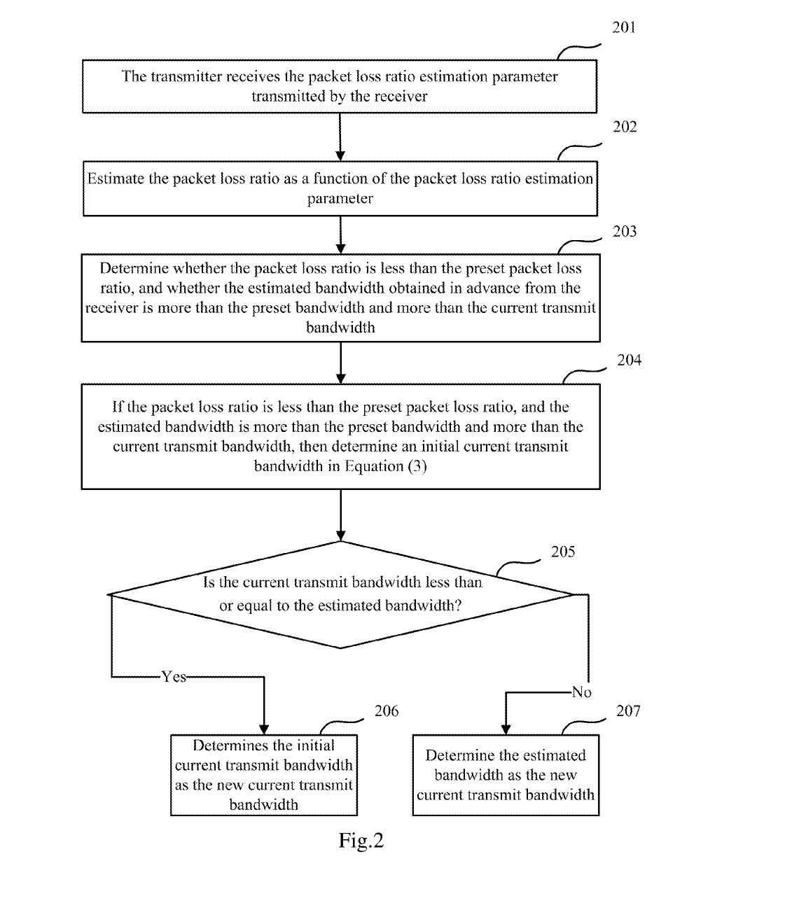

Taking Equation (3) as an example, the method for estimating a bandwidth according to the embodiment of the disclosure will be described in details with reference to particular embodiments thereof, and as illustrated in FIG. 2, there is a schematic flow chart of the method including the following steps:

Step 201, the transmitter receives the packet loss ratio estimation parameter transmitted by the receiver;

Step 202, the transmitter estimates the packet loss ratio as a function of the packet loss ratio estimation parameter;

Step 203, the transmitter determines whether the packet loss ratio is less than the preset packet loss ratio, and determines whether the estimated bandwidth obtained in advance from the receiver is more than the preset bandwidth and more than the current transmit bandwidth;

Step 204, if the packet loss ratio is less than the preset packet loss ratio, and the estimated bandwidth is more than the preset bandwidth and more than the current transmit bandwidth, then the transmitter determines an initial current transmit bandwidth in Equation (3);

Step 205, the transmitter determines whether the initial current transmit bandwidth is less than or equal to the estimated bandwidth, and if so, then the flow will proceed to the step 206; otherwise, the flow will proceed to the step 207;

Where Equation (3) has been described in the first embodiment, so a repeated description thereof will be omitted here;

Step 206, the transmitter determines the initial current transmit bandwidth as the new current transmit bandwidth; and

Step 207, the transmitter determines the estimated bandwidth as the new current transmit bandwidth.

Thus in the embodiment of the disclosure, if the transmit bandwidth can be improved by a larger factor under the good network condition, then the transmit bandwidth will be increased by more than 8%, so that the transmit bandwidth can be increased more rapidly, network resources can be made full use of, and the demand of the user can be better satisfied, thus improving the experience of the user, as compared with the prior art.

### Third Embodiment

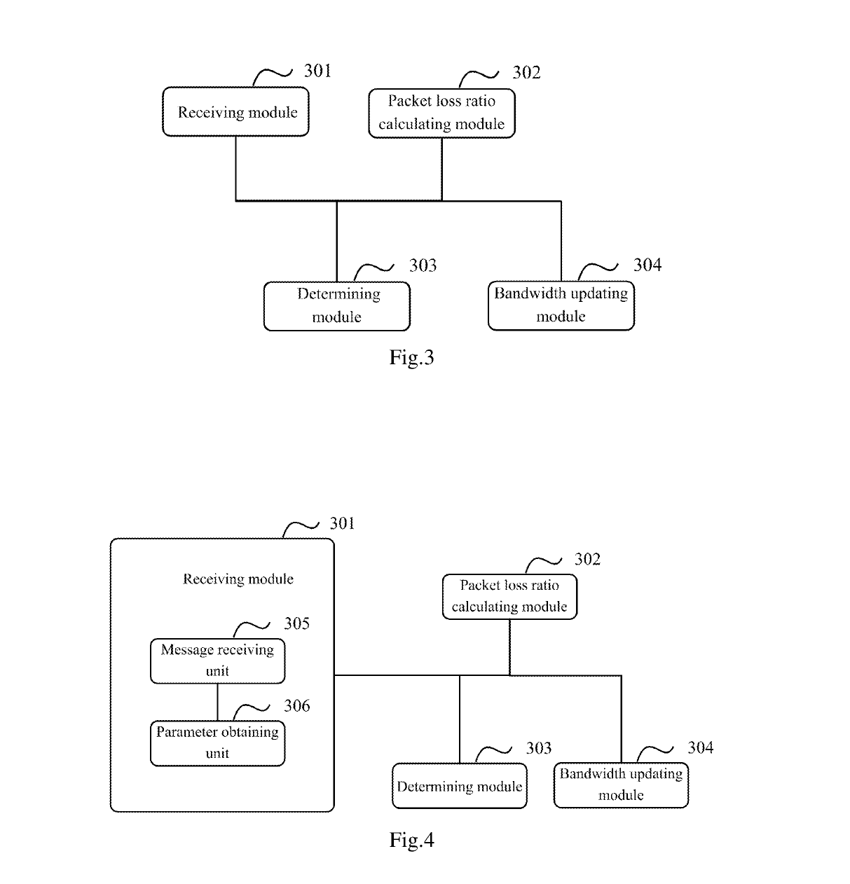

Based upon the same inventive idea, an embodiment of the disclosure further provides an apparatus for estimating a bandwidth, and as illustrated in FIG. 3, there is a schematic structural diagram of the apparatus including:

A receiving module 301 is configured to receive a packet loss ratio estimation parameter transmitted by a receiver;

A packet loss ratio calculating module 302 is configured to calculate a packet loss ratio as a function of the packet loss ratio estimation parameter;

A determining module 303 is configured to determine whether the packet loss ratio is less than a preset packet loss ratio, and to determine whether an estimated bandwidth obtained in advance from the receiver is more than a preset bandwidth and more than a current transmit bandwidth; and

A bandwidth updating module 304 is configured, if the packet loss ratio is less than the preset packet loss ratio, and the estimated bandwidth is more than the preset bandwidth and more than the current transmit bandwidth, to determine a bandwidth in a bandwidth interval as a new current transmit bandwidth, where the bandwidth interval is more than a preset multiple of the current transmit bandwidth but no more than the estimated bandwidth, where the preset multiple is more than or equal to 1.08 times.

In the apparatus for estimating a bandwidth according to the embodiments of the disclosure, if the transmit bandwidth can be improved by a larger factor under the good network condition, then the transmit bandwidth will be increased by more than 8%, and the new current transmit bandwidth will be determined from the estimated bandwidth, so that the transmit bandwidth can be increased more rapidly, network resources can be made full use of, and the demand of the user can be better satisfied, thus improving the experience of the user, as compared with the prior art.

In an embodiment, the bandwidth updating module 304 is configured:

To determine the new current transmit bandwidth as a function of the estimated bandwidth using a preset bandwidth estimation model.

Thus the reasonability of determining the new current transmit bandwidth can be improved (that is, the transmit bandwidth will be neither increased by such a small factor that it has to be increased for a number of times, nor increased by such a large factor that it may not be appropriate for the current network condition, thus degrading the data packet ratio).

In an embodiment, the preset bandwidth estimation model includes:

B′=1.08×B+(Bᵣ−B)×λ,

Where B′ represents the new current transmit bandwidth; B represents the current transmit bandwidth; Bᵣ represents the estimated bandwidth; and λ represents a first preset coefficient.

Thus the reasonability of determining the new current transmit bandwidth can be improved (that is, the transmit bandwidth will be neither increased by such a small factor that it has to be increased for a number of times, nor increased by such a large factor that it may not be appropriate for the current network condition, thus degrading the data packet ratio).

In an embodiment, the preset bandwidth estimation model includes:

B′=φ×B;φ>1.08,

Where B′ represents the new current transmit bandwidth; B represents the current transmit bandwidth; and φ represents a second preset coefficient.

Thus the reasonability of determining the new current transmit bandwidth can be improved (that is, the transmit bandwidth will be neither increased by such a small factor that it has to be increased for a number of times, nor increased by such a large factor that it may not be appropriate for the current network condition, thus degrading the data packet ratio).

In an embodiment, as illustrated in FIG. 4, the receiving module 301 particularly includes:

A message receiving unit 305 is configured to receive a Real-time Transport Control Protocol (RTCP) message including the packet loss ratio estimation parameter transmitted by the receiver; and

A parameter obtaining unit 306 is configured to obtain the packet loss ratio estimation parameter from the RTCP message.

Thus the packet loss ratio estimation parameter can be obtained as in the prior art.

In the apparatus for estimating a bandwidth according to the embodiments of the disclosure, if the transmit bandwidth can be improved by a larger factor under the good network condition, then the transmit bandwidth will be increased by more than 8%, and the new current transmit bandwidth will be determined from the estimated bandwidth, so that the transmit bandwidth can be increased more rapidly, network resources can be made full use of, and the demand of the user can be better satisfied, thus improving the experience of the user, as compared with the prior art.

### Fourth Embodiment

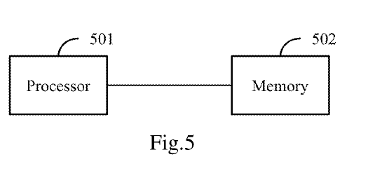

Based upon the same inventive idea, an embodiment of the disclosure further provides a electronic device, and as illustrated in FIG. 5, including:
at least one processor 501; and
a memory 502 communicably connected with the at least one processor for storing instructions executable by the at least one processor, wherein execution of the instructions by the at least one processor causes the at least one processor to:
receive a packet loss ratio estimation parameter transmitted by a receiver;
calculate a packet loss ratio as a function of the packet loss ratio estimation parameter;
determine whether the packet loss ratio is less than a preset packet loss ratio, and determine whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determine a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

In some embodiments, the processor is configured: to determine the new current transmit bandwidth as a function of the estimated bandwidth using a preset bandwidth estimation model.

In some embodiments, the preset bandwidth estimation model includes:

B′=1.08×B+(Bᵣ−B)×λ,

wherein B′ represents the new current transmit bandwidth; B represents the current transmit bandwidth; Bᵣ represents the estimated bandwidth; and λ represents a first preset coefficient.

In some embodiments, the preset bandwidth estimation model includes:

B′=φ×B;φ>1.08,

wherein B′ represents the new current transmit bandwidth; B represents the current transmit bandwidth; and φ represents a second preset coefficient.

In some embodiments, the processor is configured:
to receive a Real-time Transport Control Protocol (RTCP) message comprising the packet loss ratio estimation parameter transmitted by the receiver; and
to obtain the packet loss ratio estimation parameter from the RTCP message.

An embodiment of the disclosure disclosure provides a non-transitory computer-readable storage medium storing executable instructions that, when executed by an electronic device with a touch-sensitive display, cause the electronic device to:
receive a packet loss ratio estimation parameter transmitted by a receiver;
calculate a packet loss ratio as a function of the packet loss ratio estimation parameter;
determine whether the packet loss ratio is less than a preset packet loss ratio, and determine whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determine a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

In some embodiments, determine the bandwidth in the bandwidth interval as the new current transmit bandwidth includes:
determine the new current transmit bandwidth as a function of the estimated bandwidth using a preset bandwidth estimation model.

In some embodiments, the preset bandwidth estimation model includes:

B′=1.08×B+(Bᵣ−B)×λ,

wherein B′ represents the new current transmit bandwidth; B represents the current transmit bandwidth; Bᵣ represents the estimated bandwidth; and λ represents a first preset coefficient.

In some embodiments, the preset bandwidth estimation model includes:

B′=φ×B;φ>1.08,

wherein B′ represents the new current transmit bandwidth; B represents the current transmit bandwidth; and φ represents a second preset coefficient.

In some embodiments, receive the packet loss ratio estimation parameter transmitted by the receiver includes:
receive a Real-time Transport Control Protocol (RTCP) message comprising the packet loss ratio estimation parameter transmitted by the receiver; and
obtain the packet loss ratio estimation parameter from the RTCP message.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for estimating a bandwidth, the method comprising:
at a electronic device:
receiving, by a transmitter, a packet loss ratio estimation parameter transmitted by a receiver;
calculating a packet loss ratio as a function of the packet loss ratio estimation parameter;
determining whether the packet loss ratio is less than a preset packet loss ratio, and determining whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determining a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

2. The method according to claim 1, wherein determining the bandwidth in the bandwidth interval as the new current transmit bandwidth comprises:
determining the new current transmit bandwidth as a function of the estimated bandwidth using a preset bandwidth estimation model.

3. The method according to claim 2, wherein the preset bandwidth estimation model comprises:
B′=1.08×B+(Bᵣ−B)×λ,
wherein B′ represents the new current transmit bandwidth; B represents the current transmit bandwidth; Bᵣ represents the estimated bandwidth; and λ represents a first preset coefficient.

4. The method according to claim 2, wherein the preset bandwidth estimation model comprises:
B′=φ×B;φ>1.08,
wherein B′ represents the new current transmit bandwidth; B represents the current transmit bandwidth; and φ represents a second preset coefficient.

5. The method according to claim 4, wherein receiving the packet loss ratio estimation parameter transmitted by the receiver comprises:
receiving a Real-time Transport Control Protocol (RTCP) message comprising the packet loss ratio estimation parameter transmitted by the receiver; and
obtaining the packet loss ratio estimation parameter from the RTCP message.

6. An electronic device, comprising:
at least one processor; and
a memory communicably connected with the at least one processor for storing instructions executable by the at least one processor, wherein execution of the instructions by the at least one processor causes the at least one processor to:
receive a packet loss ratio estimation parameter transmitted by a receiver;
calculate a packet loss ratio as a function of the packet loss ratio estimation parameter;
determine whether the packet loss ratio is less than a preset packet loss ratio, and determine whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determine a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

7. The device according to claim 6, wherein the processor is configured:
to determine the new current transmit bandwidth as a function of the estimated bandwidth using a preset bandwidth estimation model.

8. The device according to claim 7, wherein the preset bandwidth estimation model comprises:
B′=1.08×B+(Bᵣ−B)×λ,
wherein B′ represents the new current transmit bandwidth; B represents the current transmit bandwidth; Bᵣ represents the estimated bandwidth; and λ represents a first preset coefficient.

9. The device according to claim 7, wherein the preset bandwidth estimation model comprises:
B′=φ×B;φ>1.08,
wherein B′ represents the new current transmit bandwidth; B represents the current transmit bandwidth; and φ represents a second preset coefficient.

10. The device according to claim 6, wherein the processor is configured:
to receive a Real-time Transport Control Protocol (RTCP) message comprising the packet loss ratio estimation parameter transmitted by the receiver; and
to obtain the packet loss ratio estimation parameter from the RTCP message.

11. A non-transitory computer-readable storage medium storing executable instructions that, when executed by an electronic device with a touch-sensitive display, cause the electronic device to:
receive a packet loss ratio estimation parameter transmitted by a receiver;
calculate a packet loss ratio as a function of the packet loss ratio estimation parameter;
determine whether the packet loss ratio is less than a preset packet loss ratio, and determine whether an estimated bandwidth obtained in advance from the receiver is more than a preset bandwidth and more than a current transmit bandwidth; and
if the packet loss ratio is less than the preset packet loss ratio, and the estimated bandwidth is more than the preset bandwidth and more than the current transmit bandwidth, then determine a bandwidth in a bandwidth interval as a new current transmit bandwidth, wherein the bandwidth interval is more than a preset multiple of the current transmit bandwidth but no more than the estimated bandwidth, wherein the preset multiple is more than or equal to 1.08 times.

12. The computer program according to claim 11, wherein determine the bandwidth in the bandwidth interval as the new current transmit bandwidth comprises:
determine the new current transmit bandwidth as a function of the estimated bandwidth using a preset bandwidth estimation model.

13. The computer program according to claim 12, wherein the preset bandwidth estimation model comprises:
B′=1.08×B+(Bᵣ−B)×λ,
wherein B′ represents the new current transmit bandwidth; B represents the current transmit bandwidth; Bᵣ represents the estimated bandwidth; and λ represents a first preset coefficient.

14. The computer program according to claim 12, wherein the preset bandwidth estimation model comprises:
B′=φ×B;φ>1.08,
wherein B′ represents the new current transmit bandwidth; B represents the current transmit bandwidth; and φ represents a second preset coefficient.

15. The computer program according to claim 14, wherein receive the packet loss ratio estimation parameter transmitted by the receiver comprises:
receive a Real-time Transport Control Protocol (RTCP) message comprising the packet loss ratio estimation parameter transmitted by the receiver; and
obtain the packet loss ratio estimation parameter from the RTCP message.
